(19) United States
(12) Patent Application Publication
(10) Pub. No.: US 2014/0359009 A1
(43) Pub. Date: Dec. 4, 2014

(54) PRIORITIZED CONTENT RETRIEVAL FROM SOCIAL NETWORK SERVERS

(71) Applicant: Microsoft Corporation, Redmond, WA (US)

(72) Inventors: Leo Shih, Palo Alto, CA (US); Apostolos Karmirantzos, Sunnyvale, CA (US); Girish Vaitheeswaran, San Jose, CA (US)

(73) Assignee: Microsoft Corporation, Redmond, WA (US)

(21) Appl. No.: 13/905,111

(22) Filed: May 29, 2013

(51) Int. Cl. H04L 29/08

(52) U.S. Cl. CPC H04L 67/306
USPC 709/204

(57) ABSTRACT

Various techniques for prioritized content retrieval from social network servers are disclosed herein. In one embodiment, a method includes receiving information of a user's profile related to a social network service provided by a social network server and generating a priority rating for the user based on the received information. The priority rating represents a likelihood of consumption of the publish content by the user. The method further includes retrieving the published content by the user from the social network server in accordance with the generated priority rating.

### BACKGROUND

Computer-based social networks can facilitate social interactions among users via the Internet or other types of computer networks. Using such social networks, users may build and maintain social relations with others who share similar interests, activities, backgrounds, or real-life connections. Users may also share with one another comments, stories, news, events, pictures, videos, and/or other types of content.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In computer-based social networks, users can produce and/or consume various types of content available on social network servers. Retrieving, storing, and cataloging such content in whole may be difficult as the number of users increases to millions, tens of millions, or even billions.

Several embodiments of the present technology provide certain approaches to prioritize retrieval of published content from social network servers based on one or more factors indicative of a likelihood of content consumption. For example, in certain embodiments, the present technology can determine priority ratings of content produced by users based on social connections or social interactions of the users on social networks, usage of the social network services by the users, and/or a type, length, or other characteristics of published content. In other examples, the present technology may also retrieve content from social network servers according to one or more behaviors of the social network servers to streamline the retrieval process. Thus, relevant, popular, and/or useful content from social networks may be efficiently and timely retrieved, stored, and cataloged for ready consumption by other users.

### BRIEF DESCRIPTION OF THE DRAWINGS

FIG. 1 is a schematic block diagram illustrating a computer framework for retrieving content from a social network server in accordance with embodiments of the present technology.

FIG. 2 is a block diagram showing software modules suitable for the policy component of FIG. 1 in accordance with embodiments of the present technology.

FIG. 3 is a flow diagram illustrating prioritized content retrieval from a social network server in accordance with embodiments of the present technology.

FIG. 4 is a schematic diagram of users of a social network in accordance with embodiments of the present technology.

FIG. 5 is a computing device suitable for certain components of the computer framework in FIG. 1.

### DETAILED DESCRIPTION

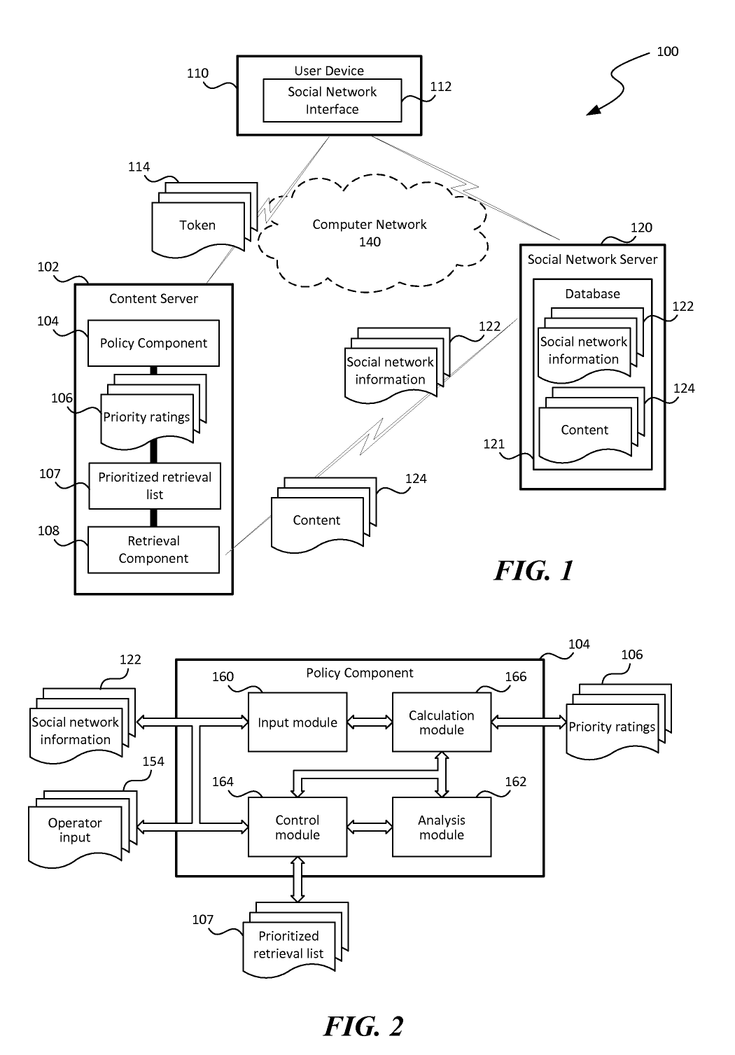

Various embodiments of systems, devices, components, modules, routines, and processes for prioritized content retrieval from social network servers are described below. In the following description, example software codes, values, and other specific details are included to provide a thorough understanding of various embodiments of the present technology. A person skilled in the relevant art will also understand that the technology may have additional embodiments. The technology may also be practiced without several of the details of the embodiments described below with reference to FIGS. 1-5.

As used herein, the term “content” generally refers to information expressed in writing, speech, photos, video recording, or any other forms of media. Also used herein, the term “social network” generally refers to a community of people, organizations, or other entities who/that communicate with one another via a computer network (e.g., the Internet), a web-site (e.g., Facebook.com), an online service (e.g., Bing Social), or other types of social network services. For example, a social network on Facebook.com may include a user and his/her friends or all users registered with Facebook.com. In another example, a social network can also include a Facebook page (e.g., Healthy Diet and Lifestyle News) and users who read, comment, like, re-post, and/or otherwise interact with the Facebook page.

With computer-based social networks, users can share with one another various types of content. Thus, users can produce and/or consume content when interacting with one another. Efficiently and timely retrieving, storing, and/or cataloging user produced content on social networks in whole may be a challenge because users can produce a large amount of content. Several embodiments of the present technology can analyze profiles of users, content produced and/or liked by users, relationships of users with one another, and/or other social network information. Based on the analysis, several embodiments of the present technology can prioritize retrieval of such content so that relevant, popular, and/or useful content may be acquired in a timely, efficient, and effective fashion. The retrieved content can then be readily consumed or accessed by users via a search engine or other suitable components.

FIG. 1 is a schematic block diagram illustrating a computer framework 100 for retrieving content from a social network server in accordance with embodiments of the present technology. As shown in FIG. 1, the computer framework 100 can include a content server 102, a user device 110, and a social network server 120 interconnected with one another via a computer network 140 (shown in phantom lines for clarity). The computer network 140 can be the Internet, an intranet, a wide area network, a virtual private network, and/or other suitable types of network. Though particular components are shown in FIG. 1, in other embodiments, the computer framework 100 can also include additional and/or different servers, user devices, communication devices, or other suitable components.

The social network server 120 can be configured to provide computer-based social network services to users. For example, in one embodiment, the social network server 120 can include a web server configured to facilitate social interactions among users in social networks via the computer network 140. In another embodiment, the social network server 120 can also include an administrative server configured to facilitate user registration, account management, and/or other function. In further embodiments, the social network server 120 can also include a mail server, an application server, a communication server, and/or other suitable types of server.

As shown in FIG. 1, the social network server 120 can include a database 121 containing records of social network information 122 and content 124. The social network information 122 can include data associated with individual users' social connections, social interactions, and/or usage of the social network services. For example, the social network information 122 can include data identifying a number of other users (referred to as “friends”) who are connected with a particular user. The social network information 122 can also include data indicating a number of the user's friends who are using the same social network services. The social network information 122 can further include data representing a frequency and/or type of social interactions by the user. Example types of social interactions can include posts, comments, and/or other forms of interactions. In other examples, the social network information 122 can also include data (e.g., retrieved content) that may be used to compute or infer various social interactions by users, as described in more detail below. In further examples, the social network information 122 can include other suitable data associated with a status and/or usage profile of the social network services by the individual users.

The content 124 can include records of various types of content individual users of the social network services publish, link, re-post, and/or otherwise expose to other users of his/her social networks. For example, the content 124 can include photos, videos, status, or comments uploaded by users to the social network server 120. The content 124 can also include a link (e.g., a web address) posted by users to the social network server 120. The link can be associated with a news article, story, video clip, document, or other media. In further examples, the content 124 can include other suitable types of information.

The user device 110 can include a social network interface 112 configured to facilitate accessing the social network server 120 by a user (not shown). The user device 110 can include a desktop, a laptop, a tablet, a smartphone, and/or other suitable types of computing device. In one embodiment, the social network interface 112 can include a web browser-based interface (e.g., a web page). In other embodiments, the social network interface 112 can include an application-based interface, a text interface, or other suitable types of interface.

Via the social network interface 112, a user can conduct various social interactions with other users of the social network services. For example, the user can view a status of friends, read comments by friends, access photos, videos, or other types of media posted by friends, see activities of friends, and/or receive other suitable information from friends. In another example, the user can also post a comment to friends, upload photos, videos, or other types of media to be viewed by friends, post a link to a story, article, or other document, and/or otherwise communicate with friends and/or non-friends.

The content server 102 can be configured to selectively retrieve, store, and catalog content 124 maintained in the social network server 120. As shown in FIG. 1, the content server 102 can include a policy component 104 configured to prioritize content retrieval from the social network server 120 and a retrieval component 108 that is configured to retrieve the social network information 122 and/or the content 124 from the social network server 120. In other embodiments, the content server 102 may also include an output component (not shown) configured to serve the stored content 124 to one or more data consumers, an input component configured to receive operator input, and/or other suitable types of components.

In certain embodiments, the policy component 104 can be configured to receive the social network information 122 from the retrieval component 108. In other embodiments, the policy component 104 can be configured to compute or infer user interactions (e.g., likes, tags, comments, etc.) or other information from the content 124. In further embodiments, the policy component 104 can also be configured to compute or infer user activities or other information from the user device 110 based on, for example, search history (e.g., using a search engine), advertisement impressions, currently active users, and/or other data on the user device 110.

The policy component 104 can then generate a plurality of priority ratings 106 (e.g., as numerical scores) for the individual users of the social network services based on the received and/or inferred information and/or other suitable information. For example, the policy component 104 can assign the policy ratings 106 for a particular user based on the user's social connections or social interactions with others in his/her social networks, usage of the social network services by the user, and/or the user's published content on the social network server 120. In certain embodiments, a user associated with the user device 110 may provide a token 114 to the content server 102 to authorize access to the social network information 122 and/or the content 124. In another embodiment, the user may authorize access to the social network information 122 and/or the content 124 by registering with the content server 102 and/or in other suitable manners. In other embodiments, such a token 114 may be omitted. Based on the generated plurality of priority ratings 106, the policy component 104 can prioritize content retrieval, crawling, and/or indexing from the social network server 120, for example, by forming a prioritized retrieval list 107 for records identifying the individual users (referred to herein as “user records”) based on the priority ratings 106 and/or other suitable parameters. The user records can include at least one of a user name, email address, home/work address, telephone number, user identification number, and/or other suitable information. Embodiments of the policy component 104 are described in more detail below with reference to FIG. 2.

The retrieval component 108 can then retrieve at least a portion of the content 124 from the social network server 120 based on the prioritized retrieval list 107. For example, the retrieval component 108 can receive a user record identifying a particular user of the social network services, send a request to the social network server 120 for all content 124 associated with the user, and receive and store the requested content 124.

In operation, users may authorize the content server 102 to receive the social network information 122 and/or the content 124 from the social network server 120 by providing the token 114, in certain embodiments. The token 114 may or may not expire after a preset period of time. In other embodiments, the user authorization may not be needed. With the token 114 or in cases where the user authorization is not needed, the content server 102 can request the social network information 122 from the social network server 120, which in turn transmits the requested social network information 122 to the content server 102.

The policy component 104 of the content server 102 then analyzes the received social network information 122 to generate the priority ratings 106 for the users associated with the received social network information 122. The priority ratings 106 individually represent a likelihood of existence of a user's published content or a likelihood of consumption of the user's published content by other users on the social network server 120. As used herein, the term “likelihood of consumption” generally refers to a likelihood that a user's published content is viewed, liked, re-posted, linked, and/or otherwise interacted with by other users. Based on the priority ratings 106, the policy component 104 can prioritize retrieval of the content 124 by identifying a subset of users whose published content 124 is more likely to exist (e.g., produced by the users after a previous retrieval) and/or be consumed than other users. In the illustrated embodiment, the policy component 104 generates the prioritized retrieval list 107 (e.g., a retrieval queue) based on the priority ratings 106. In other embodiments, the policy component 104 can also be based on other suitable criteria and/or utilize other suitable data structures. The retrieval component 108 may then retrieve content 124 based on the prioritized retrieval list 107 from the social network server 120.

FIG. 2 is a block diagram showing software modules suitable for the policy component 104 of FIG. 1 in accordance with embodiments of the present technology. As shown in FIG. 2, the policy component 104 can include an input module 160, an analysis module 162, a control module 164, and a calculation module 166 interconnected with one other. Each module may be a computer program, procedure, or routine written as source code or intermediate code in a conventional programming language, or may be hardware modules.

The input module 160 is configured to receive the social network information 122 from the social network server 120 (FIG. 1). The input module 160 can also normalize, sort, filter, remove, interpolate, extrapolate, and/or otherwise manipulate the received social network information 122 for further processing. For example, in one embodiment, the input module 160 can sort the social network information 122 based on at least one of the following parameters:
a total number of social connections of the users, e.g., provided by the users;
a number of social connections of the users on the social network;
a frequency and/or type of social interactions of the user on the social network;
a frequency of visits to the social network server 120 by the users;
a frequency of searching related to content on the social network;
a frequency of interactions with content on the social network;
amounts of published content by individual users;
a frequency of modification of the published content by individual users; or
a quality (e.g., as associated with at least one of a length, originality, or other characteristics) or type of published content by individual users.

In other embodiments, the input module 160 can be configured to filter the social network information 122 for a particular type of content (e.g., news stories, photos, or videos), a particular type of interaction (e.g., status updates or comments on other users' status updates), a particular type of users (e.g., new users), or based on other suitable criteria. In further examples, the input module 160 can manipulate other parameters of the received social network information 122 by sorting, grouping, interpolating, and/or processing in other suitable manners. The input module 160 may include comparison, recursion, character parsing, or other suitable routines. In other embodiments, the input module 160 may be configured to receive data related to behaviors of the social network server 120, operator input 154 and/or other suitable input. In further embodiments, the input module 160 may be configured to perform the foregoing and/or other suitable operations during or after processing the social network information 122 by other modules of the policy component 104.

The calculation module 166 can be configured to calculate a priority rating 106 (FIG. 1) for the individual users based on the received social network information 122. In one embodiment, the calculation module 166 can include addition modules that calculate an arithmetic sum of at least some of the foregoing parameters associated with the social network information 122. In another examples, the calculation module 166 includes addition and multiplication routines configured to compute a weighted sum of the various parameters of the social network information 122 based on weight factors included in the operator input 154.

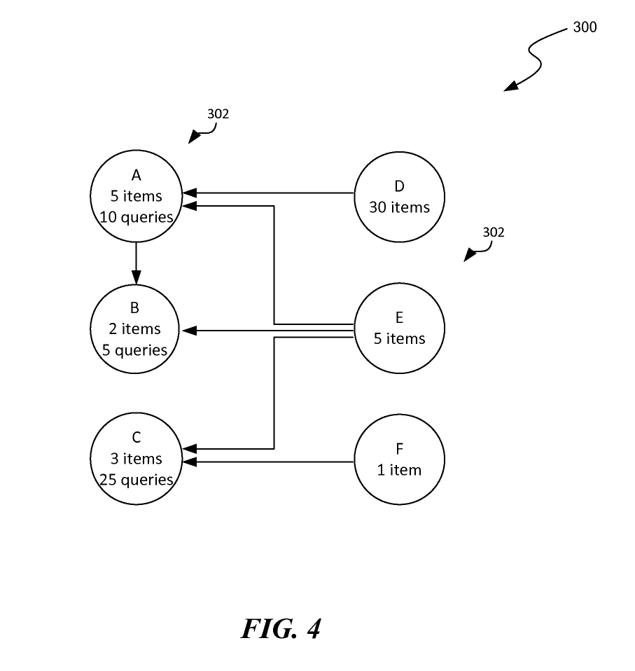

During calculations, certain parameters of the social network information 122 may be assigned numerical values. For instance, a new user may carry a numerical value that is higher than that of an existing user. A portion of updated content 124 may carry a numerical value that is higher than a portion of “stale” content 124 (i.e., one that has not been updated for a preset period of time). In further examples, the calculation module 166 may include routines for performing time averaging, window averaging, filtering, and/or other suitable operations. One example of calculating priority ratings 106 is described below in more detail with reference to FIG. 4.

The analysis module 162 may be configured to analyze the social network information 122 and/or the calculated priority ratings 106 to determine a priority level of the individual users. For example, the analysis module 162 can be configured to assign a high priority level to users whose calculated priority ratings 106 are above a preset threshold, and assign a low priority level to other users whose calculated priority ratings 106 are below or equal to the preset threshold. In other examples, the analysis module 162 can be configured to assign three, four, or any other suitable number of priority levels to the users. In further examples, instead of assigning priority levels, the analysis module 162 can be configured to rank all users based on the corresponding priority ratings 106. In yet further examples, the analysis module 162 may prioritize the users in other suitable manners. The analysis module 162 can then supply the analysis results to the calculation module 166 and/or control module 164 for further processing.

The control module 164 may be configured to generate a prioritized retrieval list 107 (FIG. 1) for the users based on inputs from the analysis module 162 and/or the calculation module 166. In one embodiment, the prioritized retrieval list 107 includes one or more retrieval queues with different retrieval frequencies. For example, the control module 164 can be configured to identify users with the assigned high priority level and insert user records associated with the identified users into a high priority retrieval queue with a high retrieval frequency (e.g., once a day). The control module 164 can also form a low priority queue with a retrieval frequency (e.g., once a week) lower than that of the high priority retrieval queue by inserting user records having the assigned low priority level. In other examples, the control module 164 can be configured to insert user records into three, four, or any suitable number of queues, stacks, or other suitable types of listing of users.

In certain embodiments, the control module 164 can also generate the prioritized retrieval list 107 at least partially based on data related to the behaviors of the social network server 120 (FIG. 1). For example, in one embodiment, the control module 164 may distribute retrieval from shared friends evenly among the tokens 114 (FIG. 1) to limit the number of retrieval requests for a particular user in a certain time period. In another embodiment, the control module 164 may generally align retrieval of the content 124 with an expiration time of the token 114, for example, by retrieving the content 124 just prior to the token 114 expires. In yet another embodiment, the control module 164 may time slice retrieval of the content 124 to avoid or reduce a risk of exceeding item limits for a single request to the social network server 120. For example, the control module 164 may retrieve portions of the content 124 in a plurality of successive time windows. Within each time window, only a portion of the content 124 with a limited size may be retrieved. In another embodiment, the control module 164 may generate the prioritized retrieval list 107 to incrementally retrieve the content 124 from the social network server 120 to avoid or reduce a risk of duplicate requests. For example, the control module 164 may track previously retrieved portions of the content 124 and only retrieve additional portions of the content 124 different than the previously retrieved portions. In further embodiments, the control module 164 may adjust retrieving the content 124 in other suitable manners.

As discussed above, by prioritizing the retrieval of the content 124 from the social network server 120, several embodiments of the present technology can acquire relevant, popular, and/or useful content 124 in a timely fashion. For example, certain pieces of the content 124 that are more likely be consumed can be acquired and/or updated more frequently (e.g., once every 24 hours) than others. Also, several embodiments of the present technology can also adjust the retrieval of the content 124 based on behaviors of the social network server 120 to reduce or eliminate the risk of overloading the social network server 120 with content retrieval requests. For example, the content 124 may be retrieved when a load is below a predetermined threshold, at a certain time of day, or under other suitable conditions indicating a light load on the social network server 120. In other examples, the content 124 may be retrieved from parts of the social network server 120 with a light load by, for example, re-prioritizing the retrieval of the content based on a current condition of the social network server 120.

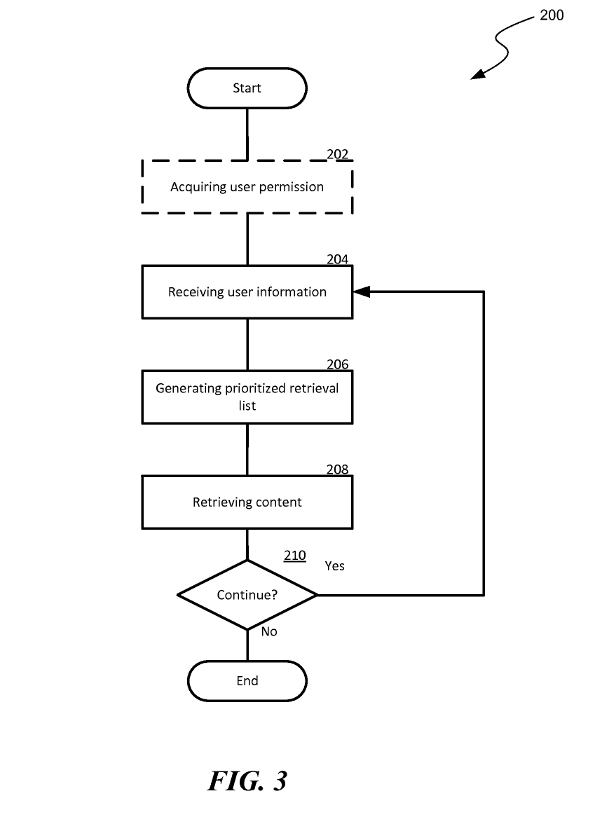

FIG. 3 is a flow diagram illustrating a process 200 for retrieving content from a social network server in accordance with embodiments of the present technology. Even though the process 200 is described below with reference to the computer framework 100 of FIG. 1 and the software modules of FIG. 2, in other embodiments, the process 200 may be implemented in other suitable computing systems.

As shown in FIG. 3, the process 200 can optionally include acquiring user permission at stage 202. In one embodiment, a user can register with the content server 102 (FIG. 1) and provide the token 114 (FIG. 1) to authorize access of the social network information 122 (FIG. 1) from the social network server 120 (FIG. 1). In another embodiment, the user may provide the token 114 in an email or other forms of electronic communication. In further embodiments, the user may set access privileges on the social network server 120 or provide other forms of authorization to allow the content server 102 to receive the social network information 122. In yet further embodiments, acquiring the user permission at stage 202 may be omitted.

The process 200 can then include receiving the social network information 122 at stage 204, for example, by the input module 160 of the policy component 104 (FIG. 2) from the social network server 120. The received social network information 122 can include various parameters related to status, activities, or other characteristics of users of social networks, as discussed above with reference to FIG. 2. The social network information 122 can also include data related to behaviors of the social network server 120. For example, the social network information 122 may include a token expiration time, item limits on content requests, notifications for new or updated content 124 (FIG. 1), and/or other suitable information.

The process 200 then includes generating one or more prioritized retrieval lists at stage 206. In one embodiment, the calculation module 166 (FIG. 2) of the policy component 104 can calculate a priority rating for each of the users based on the received social network information 122. Based on the calculated priority ratings and/or other suitable information, the analysis module 162 can assign a priority level to each of the user. The control module 164 can then generate the prioritized retrieval lists as one or more retrieval queues, each of which has a retrieval frequency, size limitation, type of retrieved content, and/or other suitable characteristics. The prioritized retrieval lists individually include one or more user records individually identifying a corresponding user.

In another embodiment, generating one or more prioritized retrieval lists can also include assigning a retrieval delay to each of the user records based on respective priority ratings. For example, if a user has a high priority rating associated with a high likelihood of consumption of published content by the user, the retrieval delay assigned to the user may be low. In another example, instead of assigning a retrieval delay, the retrieval delay may be calculated, for example, as an inversion, of the priority rating. In other examples, the retrieval delay may be derived in other suitable manners.

The process 200 can then include retrieving the content 124 from the social network server 120 at stage 208. In one embodiment, the retrieval component 108 (FIG. 1) of the content server 102 can identify a user by a corresponding user record in the prioritized retrieval list 107 and transmit a request to the social network server 120 for all published content 124 by the user. In response, the social network server 120 transmits the requested content 124 to the content server 102 for storage and/or cataloging. The retrieval component 108 can then identify additional users in the prioritized retrieval list 107 and repeat the foregoing operations through the priority retrieval list.

In certain embodiments, retrieving the content 124 can also be at least partially based on data related to the behaviors of the social network server 120. For example, in one embodiment, retrieval from shared friends may be evenly distributed among tokens 114 to limit a number of retrieval requests in a certain time period. In another embodiment, retrieval of the content 124 may be generally aligned with an expiration time of the token 114. In yet another embodiment, retrieving the content 124 may be time sliced. As such, different items of the content 124 may be retrieved at different times to avoid or reduce a risk of exceeding item lists for a single request to the social network server. In another embodiment, retrieving the content 124 may be incremental to avoid or reduce a risk of duplicate requests. In further embodiments, retrieving the content 124 may be adjusted in other suitable manner based on the behaviors of the social network server 120.

The process 200 then includes a decision stage 210 to determine if the process continues. In one embodiment, the process 200 continues if additional social network information 122 is available. Thus, the process 200 reverts to receiving the social network information at stage 204. In other embodiments, the process 200 can continue based on other suitable conditions; otherwise, the process ends.

FIG. 4 is a schematic diagram of users 302 (identified as users A-F) of a social network 300 useful in illustrating prioritized content retrieval from a social network server in accordance with embodiments of the process 200 discussed above with reference to FIG. 3. In FIG. 4, each circle represents a user with a number of items of published content and/or a number of search queries in a certain period of time (e.g., a week). For example, user A has 5 items of published content and 10 queries. User D has 30 items of published content and no queries. Also, in FIG. 4, each arrow represents a social connection between two of the users. For example, user A is connected to both user D and user E. User B is connected to user A and user E. User C is connected to user E and user F.

In the example illustrated in FIG. 4, users A-F are categorized into a high priority list with a high retrieval frequency and a low priority list with a low retrieval frequency based on (1) activities of a user (e.g., the number of item of published content) and (2) activities of the user's friends in the social network (e.g., the number of queries). Even though the prioritized content retrieval is discussed above with the particular example social network 300 and parameters thereof, in other embodiments, prioritized content retrieval may be performed in social networks with other configurations, number of users, other social network features, and/or based on other suitable parameters thereof.

In one example, a priority rating can be calculated for each of the users A-F periodically (e.g., every 24 hours) by multiplying a weighted sum of all queries of a user and the user's friends with a weighted sum of the number of items of published content by the user. Thus, according to the foregoing formula, the following table of priority ratings may be generated based on a weight factor of 1 for both parameters:

| User | Priority rating |
|---|---|
| A | (10 + 5) × 5 = 75 |
| B | (5 + 0) × 2 = 10 |
| C | (25 + 0) × 3 = 75 |
| D | (30 + 0) × 10 = 300 |
| E | (10 + 5 + 25) × 5 = 200 |
| F | (25 + 0) × 1 = 25 |

Based on the foregoing priority ratings, the users A-F may be sorted and certain users may be identified as high priority users if their priority ratings are above a preset threshold. For instance, in the example above, users D and E maybe identified as the high priority users if the threshold is 100. As such, the published content by D and E may be retrieved more frequently than that by the other users. As can be seen from this example, D and E are high priority users because (1) users D and E produce a large number of items of published content and/or (2) friends of D and E perform a large number of queries. As a result, the published content by users D and E are more likely be consumed by their friends in the social network 300 than the published content by the other users.

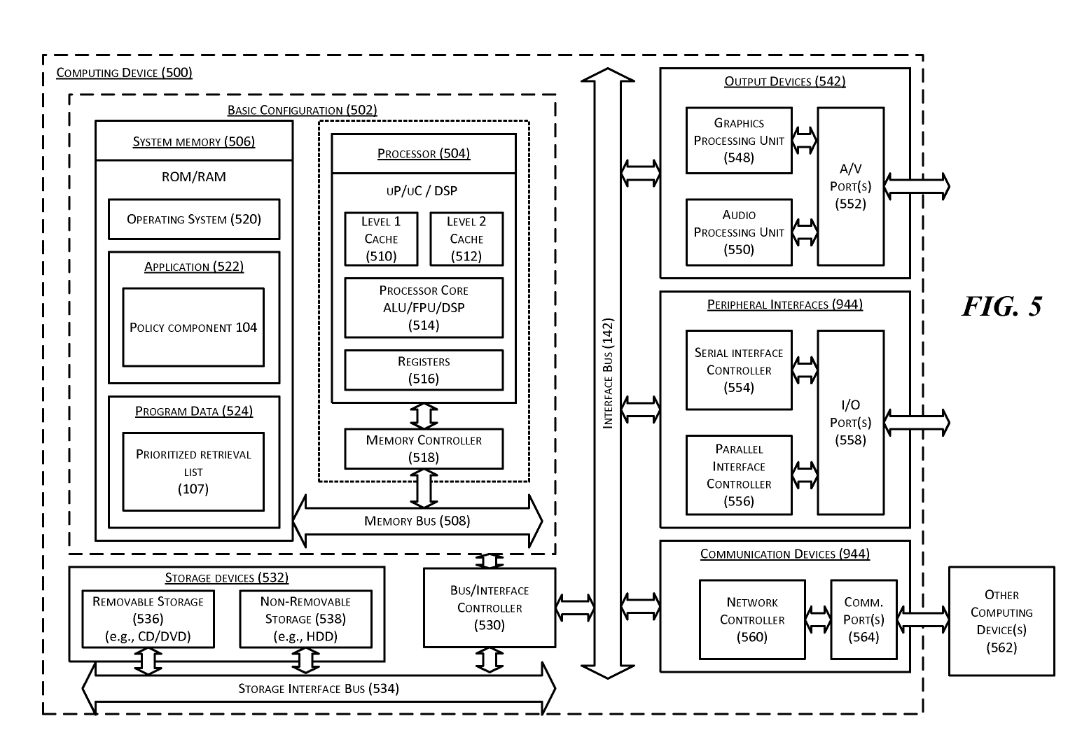

FIG. 5 is a computing device 500 suitable for certain components of the computer framework 100 in FIG. 1. For example, the computer device 500 may be suitable for the content server 102, the client device 110, or the social network server 120 of FIG. 1. In a very basic configuration 502, computing device 500 typically includes one or more processors 504 and a system memory 506. A memory bus 508 may be used for communicating between processor 504 and system memory 506.

Depending on the desired configuration, the processor 504 may be of any type including but not limited to a microprocessor (μP), a microcontroller (μC), a digital signal processor (DSP), or any combination thereof. The processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, one or more applications 522, and program data 524. The application 522 may include, for example, the policy component 104 of the content server 102 (FIG. 1). The program data 524 may include, for example, the prioritized retrieval list 107 that may be useful for prioritized content retrieval from the social network server 120 (FIG. 1) as is described herein. In some embodiments, the application 522 may be arranged to operate with program data 524 on operating system 520. This described basic configuration 502 is illustrated in FIG. 5 by those components within the inner dashed line.

The computing device 500 may have additional features or functionality, and additional interfaces to facilitate communications between basic configuration 502 and any other devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500. The term “computer storage medium” excludes propagated signals and communication media.

The computing device 500 may also include an interface bus 540 for facilitating communication from various interface devices (e.g., output devices 542, peripheral interfaces 544, and communication devices 546) to the basic configuration 502 via bus/interface controller 530. Example output devices 542 include a graphics processing unit 548 and an audio processing unit 550, which may be configured to communicate to various external devices such as a display or speakers via one or more NV ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 500 may also be implemented as a personal computer including both laptop computer and non-laptop computer configurations.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A method performed by a processor, the method comprising:
generating information related to a user of a social network service provided by a social network server, the information containing data describing at least one of the user's social connections with other users of the social network service, the user's social interactions with other users of the social network service, usage of the social network service by the user, or published content by the user via the social network service;
generating a priority rating for the user based on the received information; and
retrieving the published content by the user from the social network server in accordance with the generated priority rating.

2. The method of claim 1 wherein generating the priority rating includes analyzing the received information for at least one of a total number of social connections of the user, a number of social connections of the user on the social network service, or a frequency and/or type of social interactions of the user using the social network service.

3. The method of claim 1 wherein generating the priority rating includes:
analyzing the received information for at least one of a total number of social connections of the user, a number of social connections of the user on the social network service, or a frequency and/or type of social interactions of the user using the social network service; and
calculating a score as the priority rating based on the analyzed at least one of the total number of social connections of the user, the number of social connections of the user on the social network, or the frequency and/or type of social interactions of the user with the social network service.

4. The method of claim 1 wherein generating the priority rating includes analyzing the received information for at least one of a frequency of accessing the social network service by the user, a frequency of searching content on the social network server, or a frequency of interaction with content on the social network server.

5. The method of claim 1 wherein generating the priority rating includes:
analyzing the received information for at least one of a frequency of accessing the social network service by the user, a frequency of searching content on the social network server, or a frequency of interaction with content on the social network server; and
calculating a score as the priority rating based on the analyzed at least one of the frequency of accessing the social network service by the user, the frequency of searching content on the social network server, or the frequency of interaction with content on the social network server.

6. The method of claim 1 wherein generating the priority rating includes analyzing the received information for at least one of a number of the user's published content, a frequency of modification of the published content, a quality of the user's published content, or a type of the user's published content.

7. The method of claim 1 wherein analyzing the quality of the user's published content includes:
analyzing the received information for at least one of a number of the user's published content, a frequency of modification of the published content, a quality of the user's published content, or a type of the user's published content; and
calculating a score as the priority rating based on the analyzed at least one of a number of the user's published content, a frequency of modification of the published content, a quality of the user's published content, or a type of the user's published content.

8. The method of claim 1 wherein generating the priority rating includes:
analyzing the received information for data related to:
at least one of a total number of social connections of the user, a number of social connections of the user on the social network service, or a frequency and/or type of social interactions of the user using the social network service;
at least one of a frequency of accessing the social network service by the user, a frequency of searching content on the social network server, or a frequency of interaction with content on the social network server; and
at least one of a number of the user's published content, a frequency of modification of the published content, a quality of the user's published content, or a type of the user's published content; and
calculating a score as the priority rating based on a weighted sum of at least some of the analyzed data.

9. A computer system having a processor and a memory containing instructions that, when executed by the processor causing the processor to perform a method comprising:
analyzing information describing profiles of a plurality of users on a social network service provided by a social network server;
generating a priority rating for the individual users based on the analyzed information;
generating a list of user records individually related to the plurality of users, the list being organized based on the generated priority ratings of the plurality of users; and
retrieving published content by the users from the social network server in accordance with the generated list.

10. The computer system of claim 9 wherein generating the list includes forming a queue of the user records individually related to the plurality of users and sorting the queues based on the priority ratings of the individual users.

11. The computer system of claim 9 wherein:
generating the list includes forming a queue of the user records individually related to the plurality of users arranged in a descending order based on the priority ratings of the individual users; and
retrieving the published content includes retrieving the published content in accordance with the queue.

12. The computer system of claim 9 wherein retrieving and cataloging published content includes determining a frequency of retrieving based on the generated list of the plurality of users and retrieving the published content from the social network server in accordance with the determined frequency.

13. The computer system of claim 9 wherein generating the priority rating includes assigning a higher score for a higher value of at least one of a total number of social connections of the user, a number of social connections of the user, or a frequency and/or type of social interactions of the user using the social network service.

14. The computer system of claim 9 wherein generating the priority rating includes assigning a higher score for a higher value of at least one of a frequency of accessing the social network service by the user, a frequency of searching content on the social network server, or a frequency of interaction with the content on the social network server.

15. The computer system of claim 9 wherein generating the priority rating includes assigning a higher score for a higher value of at least one of a quantity of the user's published content, a frequency of modification of the published content, a quality of the user's published content, or a type of the user's published content.

16. The computer system of claim 9 wherein the method further includes:
receiving additional information related to activities of the plurality of users on the social network service;
analyzing the received additional information;
updating the priority rating for the individual users based on the analyzed additional information; and
updating the list of the plurality of users based on the updated priority ratings of the plurality of users.

17. A computer storage medium containing instructions that, when executed by a processor causing the processor to perform a method comprising:
generating information of a plurality of users' profile related to a social network service provided by a social network server, the information containing data describing at least one of the users' social connections with other users of the social network service, the users' social interactions with other users of the social network service, usage of the social network service by the users, and/or published content by the users via the social network service;
analyzing the received information for data related to:
at least one of a total number of social connections of the users, a number of social connections of the users on the social network service, or a frequency and/or type of social interactions of the users using the social network service;
at least one of a frequency of accessing the social network service by the users, a frequency of searching content on the social network server, or a frequency of interaction with content on the social network server; or
at least one of a number of the users' published content, a frequency of modification of the published content, a quality of the users' published content, or a type of the users' published content;
generating a priority rating for the individual users based on the analyzed data, the priority ratings representing at least one of a likelihood of existence of the published content by the individual users or a likelihood of consumption of the published content by other users on the social network service;
forming a queue of user records individually related to the plurality of users arranged based on the generated priority ratings of the individual users; and
retrieving the published content by the users from the social network server in accordance with the formed queue.

18. The computer storage medium of claim 17 wherein:
analyzing the received information includes determining a number of searching related to the published content on the social network for one of the users and other users connected with the one of the users and a number of the published content of the one of the users; and
generating the priority rating includes generating the priority rating for the one of the users as a product of the number of searching related to the published content on the social network and the number of the published content of the one of the users.

19. The computer storage medium of claim 17 wherein retrieving the published content includes retrieving the published content based on a behavior of the social network server.

20. The computer storage medium of claim 17 wherein retrieving the published content includes at least one of:
distributing retrieval from users with shared connections evenly among tokens;
retrieving the published content generally aligned with an expiration time of the tokens;
retrieving the published content with in a time sliced fashion; or
retrieving the published content with in an incremental fashion.
